(19) United States
(12) Patent Application Publication
(10) Pub. No.: US 2008/0052459 A1
(43) Pub. Date: Feb. 28, 2008

(54) Redundant array of independent disks system

(75) Inventors: Shi-Fan Chang, (US); Yung-Fu Chen, (US)

Correspondence Address: BIRCH STEWART KOLASCH & BIRCH, PO BOX 747, FALLS CHURCH, VA, 22040-0747, US

(73) Assignee: iCreate Technologies Corporation

(21) Appl. No.: 11/878,563

(22) Filed: Jul. 25, 2007

(30) Foreign Application Priority Data
Aug. 25, 2006 (TW) 095131246

(51) Int. Cl. G06F 13/28

(52) U.S. Cl. 711/114; 711/E12.002

(57) ABSTRACT

A redundant array of independent disks (RAID) system is provided, comprising a nonvolatile memory card array and a RAID controller. Wherein, the non-volatile memory card array consists of at least a non-volatile memory card. The invention has several advantages such as capability to expand storage capacity according to users' needs, shake-proof, abrasion-proof and great adaptability for environment.

### BACKGROUND OF THE INVENTION

1. Field of the invention

The invention relates to redundant array of independent disks (RAID), and more particularly, to a RAID system consisting of a plurality of nonvolatile memory cards serving as assembly units.

2. Description of the Related Art

A conventional RAID system integrates a plurality of hard disks into a massive single-volume virtual hard disk by means of a RAID controller. Its main features are as follows. 1) Data access is accelerated due to concurrently reading the plurality of hard disks. 2) Fault tolerance and expansion capabilities are provided. 3) It serves as an ordinary storage system instead of a backup solution. In general, conventional RAID systems employ motor-driving mechanical hard disks. However, mechanical components of the motor-driving mechanical hard disks are bulky and vulnerable to abrasion, vibration and high temperature, thus rendering the conventional RAID systems a limited application.

Presently, some hard disks or RAID systems directly use nonvolatile memory components (such as flash memory components) as storage units. However, electric characteristics among flash memory components manufactured by different manufacturers may not be the same or even not compatible to each other. As a result, this causes the hard disks or RAID systems using the nonvolatile memory components as storage units to have a complicated manufacturing and design process and a high hardware cost. Further, to hard disk or RAID system manufacturers, the non-volatile memory components are not handy to get. In contrast, to end users, the non-volatile memory components have already been soldered inside hard disks or RAID systems before delivery, definitely impossible to expand the storage capacity after purchase.

Thus, there is a need for an efficient RAID system to solve the aforementioned problems.

### SUMMARY OF THE INVENTION

In view of the above-mentioned problems, an object of the invention is to provide a RAID system consisting of non-volatile memory cards configured as an assembly unit.

To achieve the above-mentioned object, the RAID system comprises: a nonvolatile memory card array having at least one nonvolatile memory card; and, a RAID controller coupled to both a host system via a RAID interface and the nonvolatile memory card array.

Wherein, a physical interconnection between the at least one nonvolatile memory card and the RAID controller is selected from the group comprising a point-to-point topology, a shared-bus topology and a combined topology. An interface between each nonvolatile memory card and the RAID controller is selected from the group comprising a compact flash (CF) card interface, a secure digital (SD) card interface, a memory stick (MS) interface, an xD-picture card interface, a smart media (SM) card interface, a micro drive interface, a universal serial bus (USB) interface and a multi media card (MMC) interface.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1A is a schematic circuit diagram showing an embodiment of the invention.

FIG. 1B is a schematic circuit diagram showing another embodiment of the invention.

FIG. 2 shows an example that memory spaces of all nonvolatile memory cards are mapped into a single continuous memory space.

FIG. 3 shows another example that memory spaces of all nonvolatile memory cards are mapped into a single continuous memory space.

### DETAILED DESCRIPTION OF THE INVENTION

The RAID system of the invention will be described with reference to the accompanying drawings.

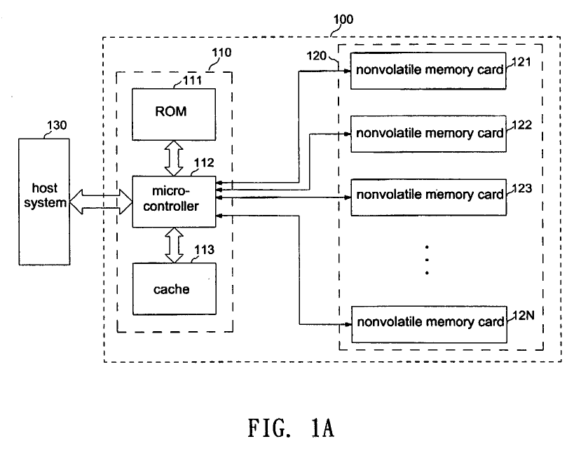

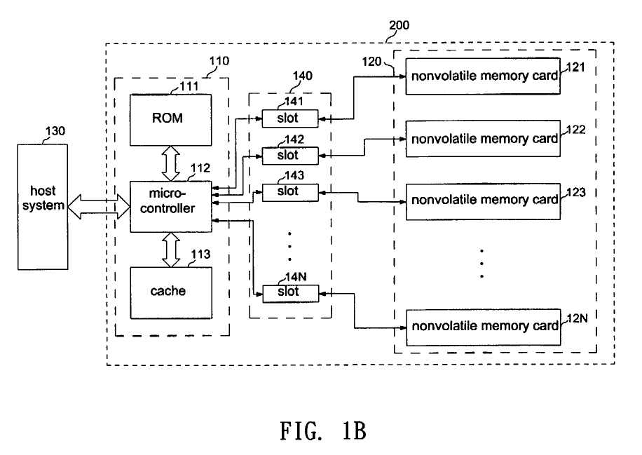

FIG. 1A is a schematic circuit diagram showing an embodiment of the invention. Referring to FIG. 1A, according to the invention, a RAID system 100 comprises a RAID controller 110 and a nonvolatile memory card array 120. The nonvolatile memory card array 120 includes at least one nonvolatile memory card (121-12N) arranged in an array, where N is a positive integer and N≧1. The RAID controller 110 is coupled to both a host system 130 and the nonvolatile memory card array 120.

A feature of the invention is that each nonvolatile memory card serves as a storage unit or an assembly unit in the RAID system 100. In functionality, each nonvolatile memory card (121-12N) is equivalent to a hard disk of a conventional RAID system. The nonvolatile memory cards 121-12N are integrated into a nonvolatile memory card array 120, all of which are under the control of the RAID controller 110. From the point of view of the host system 130, the RAID controller 110 seems like a single-volume memory card system; besides, a storage capacity of the nonvolatile memory card array 120 is the sum total of storage capacities of the nonvolatile memory cards 121-12N.

The RAID controller 110 at least comprises a read-only memory (or a synchronous dynamic random access memory (SDRAM), or a flash memory) 111, a micro-controller 112 and a cache random access memory 113. The micro-controller 112 responds to requests from both the host system 130 and the nonvolatile memory card array 120 so as to execute read instructions and write instructions. The cache random access memory 113 coupled to the micro-controller 112 temporarily stores access data of both the host system 130 and the nonvolatile memory card array 120, whereas the read-only memory 111 coupled to the micro-controller stores programs that control all access operations from the host system 130 to the nonvolatile memory card array 120. It should be noted that the particular configuration of the RAID controller disclosed above is illustrative only, as various changes and modifications thereof may be made without departing from the spirit of the invention.

According to the invention, the micro-controller 112 is coupled to the host system 130 via a RAID array interface. The RAID array complies with one or more interface standards, including but not limited to the following interface standards: serial advanced technology attachment (SATA), serial attached small computer system (SAS), advanced technology attachment packet interface (ATAPI), small computer system interface (SCSI), universal serial bus (USB), intelligent drive electronics (IDE) and peripheral component interconnect (PCI). It should be understood, however, that the invention is not limited to the specific interface standards described above, but fully extensible to any existing or yet-to-be developed interface standards.

In this embodiment, a physical interconnection between the nonvolatile memory cards 121-12N and the RAID controller 110 can be implemented with one of the following three topologies. 1) Point-to-point topology: Each nonvolatile memory card (121-12N) is coupled to the RAID controller 110 using a dedicated or individual physical line. 2) Shared-bus topology: Different nonvolatile memory cards 121-12N share the same physical line so as to couple with the RAID controller 110. 3) Combined topology: The point-to-point and the shared-bus topologies simultaneously exist and are jointly implemented in the RAID system 100.

On the other hand, an interface between each nonvolatile memory card (121-12N) and the RAID controller 110 complies with one or more memory card interface standards, including but not limited to the following memory card interface standards: Compact Flash (CF), Secure Digital (SD), Memory Stick (MS), xD-Picture Card, Smart Media (SM), Micro Drive, Universal Serial Bus (USB) and Multi Media Card (MMC). It should be appreciated, however, that the invention is not limited to the specific memory card interface standards described above, but fully extensible to any existing or yet-to-be developed memory card interface standards. The nonvolatile memory cards 121-12N may differ from one another in supporting different memory card interface standards. Even though the nonvolatile memory cards 121-12N support the same memory card interface, they may also differ from one another in their form factors or sizes. For example, in addition to a regular size SD card, mini-SD card and micro-SD card smaller in size also support SD memory card interface. In addition to a regular size MMC card, RS-MMC card and micro-MMC card smaller in size also support MMC memory card interface. Further, a small size memory stick pro and a regular size memory stick support MS interface. The nonvolatile memory card (121-12N) further comprises a flash disk compliant with an USB interface.

Conventional hard disks or RAID systems directly using non-volatile memory components as storage units have drawbacks of complicated design, inconvenience of buying nonvolatile memory components and lack of flexibility in expanding storage capacity. In contrast, the invention has advantages such as easy design, convenience of buying nonvolatile memory cards, capability to expand storage capacity according to users' needs, shake-proof, abrasion-proof and great adaptability for environment. It should be noted that although nonvolatile memory cards substitute as the assembly units, the invention also provides fault tolerance to increase reliability as well.

FIG. 1B is a schematic circuit diagram showing another embodiment of the invention.

While entering a commodity phase, a RAID system 200 is a vacant box (similar in appearance to a conventional hard disk external box) consisting of a RAID controller 110 and either a plurality of memory card slots 141-14N or a slot array 140, the storage capacity of which equal to zero. Before delivery, a plurality of memory cards 121-12N are assembled or inserted into the plurality of memory card slots 141-14N correspondingly according to the storage capacity as customers require. Alternatively, end users may purchase additional memory cards to expand the storage capacity later on, making the storage capacity expansion convenient and flexible. Hence, the invention features in easy manufacturing process, convenient assembly and flexibility in expanding storage capacity, thus suitable for mass production and merchandising purposes.

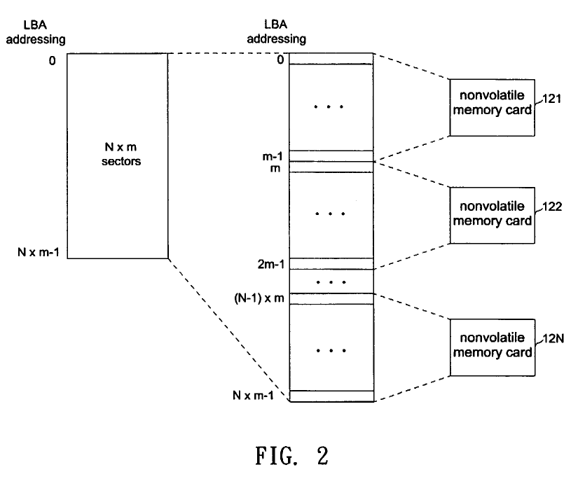

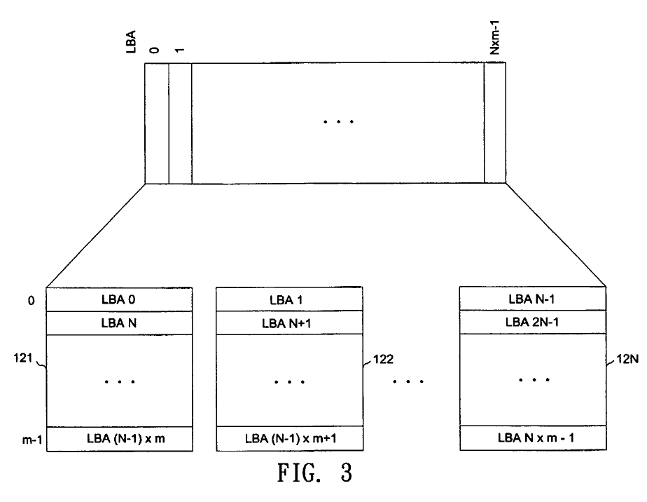

As to addressing, a conventional mechanical hard disk employs a Cylinder/Head/Sector (CHS) addressing in terms of cylinder, head and sector numbers. Instead, the RAID system (100, 200) of the invention maps a large memory space into all memory spaces of the nonvolatile memory cards 121-12N using a logical block addressing (LBA). In practical applications, there are several mapping methods to integrate all discontinuous diverse memory spaces of the nonvolatile memory cards 121-12N into a single continuous memory space. Hereinafter, two mapping examples are described in accordance with FIGS. 2 and 3.

FIG. 2 shows an example that memory spaces of all nonvolatile memory cards are mapped into a single continuous memory space.

FIG. 3 shows another example that memory spaces of all nonvolatile memory cards are mapped into a single continuous memory space.

Referring to FIGS. 2 and 3, each sector serves as an addressing unit in nonvolatile memory cards 121-12N. Suppose that each nonvolatile memory card (121-12N) has m (m≧1, m is a positive integer) sectors and therefore there are totally (N×m) sectors for the nonvolatile memory card array 120. The memory mapping scheme as shown in FIG. 2 is a sequential mapping, with the best capacity usage and the worst read/write performance. Ordinarily, there is a high probability of sequentially accessing a memory card, therefore unable to avoid a latency period caused by accessing two successive sectors of that memory card. In contrast, it is an interlaced mapping as shown in FIG. 3, where each file is stored in an interlaced way. Suppose that a file is stored into two sectors corresponding to two individual nonvolatile memory cards. While reading the file, two latency periods for accessing the two sectors are substantially overlapped, therefore reducing the total latency period and improving read/write performance but having worse capacity usage.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. A redundant array of independent disks (RAID) system, comprising:
a nonvolatile memory card array having at least one nonvolatile memory card; and
a RAID controller coupled to both a host system via a RAID interface and the nonvolatile memory card array.

2. The RAID system according to claim 1, wherein an interface between each nonvolatile memory card and the RAID controller is selected from the group comprising a compact flash (CF) interface, a secure digital (SD) interface, a memory stick (MS) interface, an xD-picture card interface, a smart media (SM) interface, a micro drive interface, an universal serial Bus (USB) interface and a multi media card (MMC) interface.

3. The RAID system according to claim 1I wherein a physical interconnection between the at least one nonvolatile memory card and the RAID controller is selected from the group comprising a point-to-point topology, a shared-bus topology and a combined topology.

4. The RAID system according to claim 1, wherein the RAID interface is selected from the group comprising a serial advanced technology attachment (SATA) interface, a serial attached small computer system (SAS) interface, an advanced technology attachment packet interface (ATAPI), a small computer system interface (SCSI), an universal serial bus (USB) interface, an intelligent drive electronics (IDE) interface and a peripheral component interconnect (PCI) interface.

5. The RAID system according to claim 1, wherein the RAID controller comprises:
a micro-controller responsive to requests from both the host system and the nonvolatile memory card array for executing read instructions and write instructions;
a cache random access memory coupled to the micro-controller for temporarily storing access data of both the host system and the nonvolatile memory card array; and
a read-only memory coupled to the micro-controller for storing programs that control the host system to access the nonvolatile memory card array.

6. A redundant array of independent disks (RAID) system, comprising:
a plurality of memory card slots, wherein a first memory card slot is configured to accommodate a removable nonvolatile memory card; and
a RAID controller coupled to the plurality of memory card slots.

7. The RAID system according to claim 6, further comprising:
a plurality of nonvolatile memory cards set inside the plurality of memory card slots correspondingly.

8. The RAID system according to claim 7, wherein the RAID controller accesses the plurality of nonvolatile memory cards using a logic block addressing mode.

9. The RAID system according to claim 8, wherein the logic block addressing mode uses a sequential mapping to access the plurality of nonvolatile memory cards.

10. The RAID system according to claim 8, wherein the logic block addressing mode uses an interlaced mapping to access the plurality of nonvolatile memory cards.
